(19) United States
(12) Patent Application Publication
(10) Pub. No.: US 2012/0002076 A1
(43) Pub. Date: Jan. 5, 2012

(54) CAMERA AND IMAGE PROCESSING APPARATUS

(75) Inventors: Akihiko TAKAHASHI, Kawasaki-shi (JP); Shigemasa SATO, Yokohama-shi (JP)

(73) Assignee: NIKON CORPORATION, TOKYO (JP)

(21) Appl. No.: 13/172,301

(22) Filed: Jun. 29, 2011

(30) Foreign Application Priority Data
Jul. 1, 2010 (JP) 2010-150815

(51) Int. Cl. H04N 5/76

(52) U.S. Cl. 348/231.2; 348/E05.031

(57) ABSTRACT

A camera includes: a photographing unit that generates image files by consecutively capturing subject images at an electronic shutter speed high enough to ensure that no image blur occurs in the subject images; an image file recording unit that records image files into a storage medium; a setting unit that sets a movie image frame rate; a synthetic image generation unit that generates a plurality of synthetic images each by combining sets of image data in image files among a plurality of image files generated by the photographing unit, a quantity of the sets of image data being set by taking into consideration the frame rate set by the setting unit; and a movie image file generation unit that generates a movie image file containing a movie image, each frame of the movie image being constituted with one of the synthetic images.

### INCORPORATION BY REFERENCE

The disclosure of the following priority application is herein incorporated by reference:

Japanese Patent Application No. 2010-150815 filed Jul. 1, 2010

### BACKGROUND OF THE INVENTION

1. Field of the Invention

The present invention relates to a camera and an image processing apparatus.

2. Description of Related Art

An image capturing apparatus disclosed in Japanese Laid Open Patent Publication No. 2007-274210 generates a movie image by combining still image signals output from an image sensor.

### SUMMARY OF THE INVENTION

However, the image capturing apparatus in the related art, which synthetically generates a movie image by combining image signals output from an image sensor, is not able to retain the still images used as the movie image generation source.

According to the 1st aspect of the present invention, a camera comprises: a photographing unit that generates image files by consecutively capturing subject images at an electronic shutter speed high enough to ensure that no image blur occurs in the subject images; an image file recording unit that records image files into a storage medium, the image files being generated by the photographing unit; a setting unit that sets a movie image frame rate; a synthetic image generation unit that generates a plurality of synthetic images each by combining sets of image data in image files among a plurality of image files generated by the photographing unit, a quantity of the sets of image data being set by taking into consideration the frame rate set by the setting unit; and a movie image file generation unit that generates a movie image file containing a movie image, each frame of the movie image being constituted with one of the synthetic images generated by the synthetic image generation unit.

According to the 2nd aspect of the present invention, a camera according to the 1st aspect may further comprise: a movie image file recording unit that records the movie image file generated by the movie image file generation unit into the storage medium.

According to the 3rd aspect of the present invention, the synthetic image generation unit in a camera according to the 2nd aspect may generate the synthetic images by excluding any image file that should not be used as a generation source when generating the synthetic images, among the plurality of image files containing the image data generated by the photographing unit.

According to the 4th aspect of the present invention, it is preferred that in a camera according to the 3rd aspect, the synthetic image generation unit identifies an image with an unwanted object present therein, an image manifesting image blur or an image in which a primary subject having been consistently present in preceding images is missing, as the image file that should not be used as a generation source.

According to the 5th aspect of the present invention, it is preferred that in a camera according to the 1st aspect, the plurality of image files are generated through continuous shooting by the photographing unit.

According to the 6th aspect of the present invention, a camera according to the 5th aspect may further comprise: a sound recording unit that records ambient sound while the continuous shooting executed by the photographing unit is in progress; and an audio data adding unit that adds audio data obtained by the sound recording unit to the movie image file when the movie image is reproduced.

According to the 7th aspect of the present invention, it is preferred that in a camera according to the 6th aspect, the sound recording unit appends a time stamp to the audio data having been obtained; and the audio data adding unit adds the audio data to the movie image file by maintaining correct correspondence between individual frames of the movie image and the audio data based upon the time stamp.

According to the 8th aspect of the present invention, an image processing apparatus comprises: an acquisition unit that obtains a plurality of sets of image data generated in a camera that consecutively captures subject images at an electronic shutter speed high enough to ensure that no image blur occurs in the subject images; a save unit that saves the plurality of sets of image data obtained via the acquisition unit; a setting unit that sets a movie image frame rate; a synthetic image generation unit that generates a plurality of synthetic images each by combining sets of image data in image files among a plurality of image files generated in the camera a quantity of the sets of image data being set by taking into consideration the frame rate set by the setting unit; and a movie image file generation unit that generates a movie image file containing a movie image, each frame of the movie image being constituted with one of the synthetic images generated by the synthetic image generation unit.

According to the present invention, the still images can be retained together with the movie image.

### BRIEF DESCRIPTION OF THE DRAWINGS

FIG. 1 is a block diagram showing the structure adopted in a camera 100 achieved in an embodiment.

FIG. 2 presents a first diagram schematically illustrating how a movie image may be created by combining still images in a specific example.

FIG. 3 presents a second diagram schematically illustrating how a movie image may be created by combining still images in a specific example.

FIG. 4 presents a third diagram schematically illustrating how a movie image may be created by combining still images in a specific example.

FIG. 5 is a block diagram showing the structure of a camera 100 equipped with a microphone.

FIG. 6 is a block diagram showing the structure of an image processing apparatus.

### DESCRIPTION OF PREFERRED EMBODIMENTS

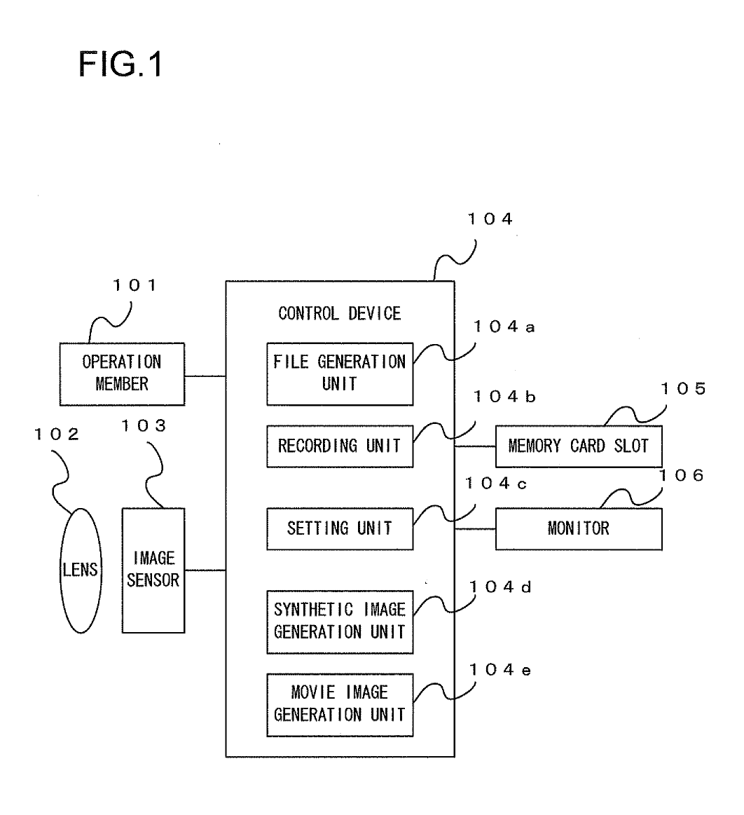

FIG. 1 is a block diagram of a structural mode that may be adopted in the camera achieved in an embodiment. A camera 100 comprises an operation member 101, a lens 102, an image sensor 103, a control device 104, a memory card slot 105 and a monitor 106. The operation member 101 includes various input members operated by the user, such as a power button, a shutter release button, a zoom button, a cross key, an OK button, a reproduce button and a delete button

While the lens 102 is constituted of a plurality of optical lenses, FIG. 1 only shows a single representative lens. The image sensor 103, which may be a CCD image sensor or a CMOS image sensor, captures a subject image formed through the lens 102. Image signals expressing the captured image are then output to the control device 104.

The control device 104, constituted with a CPU, a memory and various peripheral circuits, controls the camera 100. It is to be noted that the memory in the control device 104 includes an SDRAM and a flash memory. The SDRAM, which is a volatile memory, is used as a work memory where a program executed by the CPU is expanded for program execution or as a buffer area where data are temporarily recorded. The flash memory, on the other hand, is a nonvolatile memory where data for the program executed by the control device 104, various parameters that are read during the program execution and the like are recorded.

The control device 104 has functions fulfilled by a file generation unit 104a, a recording unit 104b, a setting unit 104c, a synthetic image generation unit 104d and a movie image generation unit 104e. The file generation unit 104a generates image data in a predetermined image format such as the PEG format based upon image signals input thereto from the image sensor 103. The file generation unit 104a then generates an image file by appending thumbnail data, generated based upon the image data, and header information that includes a photographic information and the like, to the image data. The recording unit 104b outputs the image file thus generated to the memory card slot 105 where the image file is recorded into a memory card. It is to be noted that the setting unit 104a, the synthetic image generation unit 104b and the movie image generation unit 104e will be described in detail later.

The memory card slot 105 is a slot where a memory card, used as a storage medium, is loaded, and data files (still image files and movie image files) output by the control device 104 are written and thus recorded in the memory card. In addition, a data file stored in the memory card is read via the memory card slot 105 in response to an instruction issued by the control device 104.

At the monitor 106, which is a liquid crystal monitor (rear-side monitor) mounted at the rear surface of the camera 100, an image resulting from reproduction of a still image file or a movie image file stored in the memory card, a setting menu enabling selection of settings for the camera 100, and the like are displayed. In addition, as the user sets the camera in a photographing mode, the control device 104 displays a through image at the monitor 106 based upon image signals obtained in time series from the image sensor 103.

A high-speed continuous shooting function, which allows the camera 100 in the embodiment to shoot still images at a shutter speed specified by the user, e.g., 1/600 sec, and then record the plurality of image files created through the shooting operation into a memory card, is available in the camera 100. The shutter speed (the length of time for charge storage at the image sensor) specified by the user is an electronic shutter speed that is fast enough to prevent any image blur in the subject image, and is achieved through an electronic shutter function of the known art that is built into the image sensor. The camera 100 in the embodiment also has a function of movie image generation for generating movie image data by using image data in a plurality of image files recorded into the memory card through a high-speed continuous shooting operation. More specifically, the user is able to specify a frame rate for the movie image to be generated. Based upon the movie image frame rate specified by the user, the setting unit 104c sets a movie image frame rate. The synthetic image generation unit 104d generates a plurality of sets of synthetic image data by combining image data expressing a plurality of still images having been obtained through the high-speed shooting operation. The movie image generation unit 104e then generates movie image data with each set of synthetic image data having been generated expressing a specific frame of image among the frames of images constituting the movie image.

The movie image generation unit 104e generates a movie image file by appending header information and the like to the movie image data thus generated, and the recording unit 104b records the movie image file having been generated into the memory card. The image files containing the still images obtained through the continuous shooting operation and the movie image file created based upon the continuously shot images can thus both be saved in the memory card.

For instance, the user may specify a movie image frame rate of 60 fps. In this situation, if a high-speed continuous shooting operation is executed at a continuous shooting speed of 600 fps (with a shutter speed faster than 1/600 sec), the synthetic image generation unit 104d generates synthetic image data by combining the image data expressing still images in ten consecutive frames among the sets of image data expressing still images obtained through the high-speed continuous shooting operation. The synthetic image generation unit 104d thus creates synthetic image data equivalent to a single frame of image (shot with a shutter speed of 1/60 sec) among frames of images captured at the continuous shooting speed of 60 fps. The synthetic image generation unit 104d generates a plurality of sets of synthetic image data by sequentially combining image data expressing still images in ten consecutive frames at a time. Movie image data with a frame rate of 60 fps are generated by the movie image generation unit 104e, which generates movie image data with each of the plurality of sets of synthetic image data constituting a frame in the movie image.

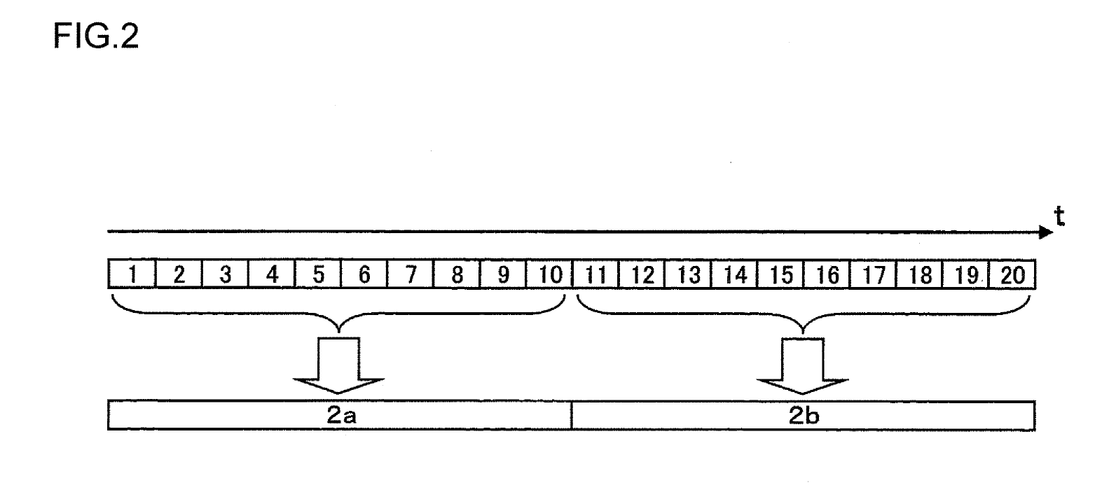

In more specific terms, the control device 104, having shot twenty frames of still images at the continuous shooting speed of 600 fps (with a shutter speed faster than 1/600 sec) as shown in FIG. 2, generates movie image data as described below. The synthetic image generation unit 104d creates synthetic image data for a frame 2a equivalent to a frame of image captured at the continuous shooting speed of 60 fps (captured at a shutter speed of 1/60 sec) by combining the image data expressing the still images in the first ten frames, first through 10th frames, obtained in time series and creates synthetic image data for a frame 2b equivalent to a frame of image captured at the continuous shooting speed of 60 fps (captured at a shutter speed of 1/60 sec) by combining the image data expressing the still images in another ten frames, i.e., the eleventh through twentieth frames obtained in time series. The movie image generation unit 104e then creates movie image data with a frame rate of 60 fps with the synthetic image data for the frame 2a and the synthetic image data for the frame 2b each constituting a specific frame in the movie image data.

It is to be noted that in the example described in reference to FIG. 2, movie image data with a frame rate of 60 fps are created based upon still images obtained through a high-speed continuous shooting operation with the continuous shooting speed set at 600 fps (with a shutter speed faster than 1/600 sec) and thus, the frames of the movie image are each generated by combining still images in groups of ten frames. However, if the frame rate specified by the user is 30 fps, for instance, each frame in the movie image will be created by combining still images in twenty frames, instead.

The synthetic image generation unit 104d in the embodiment combines the image data expressing still images in the frames, the quantity of which corresponds to the specified movie image frame rate, among the frames of still images obtained in time series through a high-speed continuous shooting operation, as shown in FIG. 2. However, if there is any frame to be rejected (a rejection-target frame) that should not be included in the frames to be used for synthetic image generation, the synthetic image generation unit 104d excludes the rejection-target frame when generating synthetic data. Such a rejection-target frame that should be excluded may be a frame of image in which an unwanted object is included, a frame of image manifesting image blur (an unfocused image), a frame of image in which a primary subject having been consistently present in the preceding frames is missing, or the like. It is to be noted that since the image data in a rejection-target frame to be excluded in the synthetic image generation can be identified through a method of the known art by, for instance, ascertaining frame-to-frame differences among sets of image data corresponding to the individual frames, a detailed description of a method that may be adopted for purposes of identifying such image data is not provided.

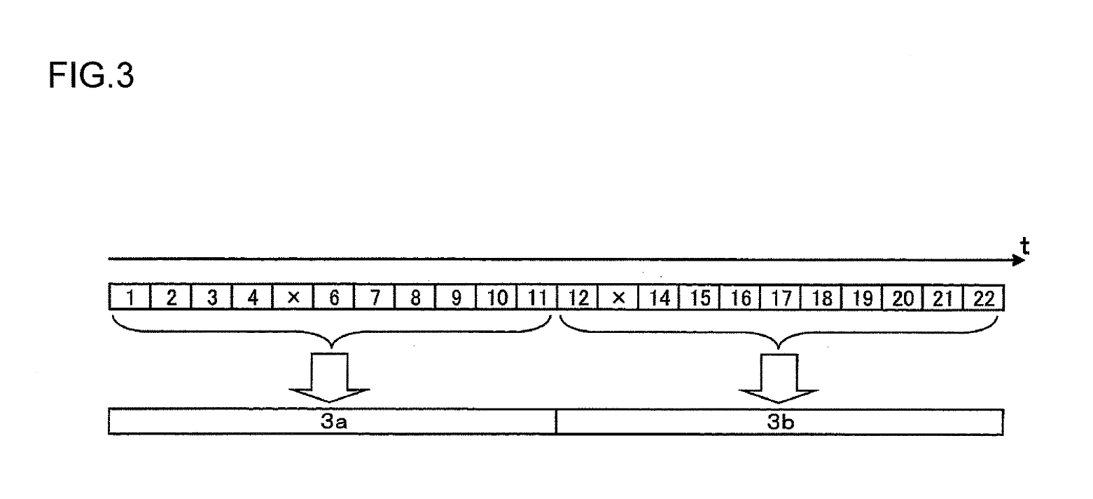

FIG. 3 shows how movie image data may be created in a specific example by combining image data expressing still images after excluding the image data in any rejection-target frame that should be excluded in the synthetic image generation. In the example presented in FIG. 3, the image data in the fifth frame and the image data in the thirteenth frame are rejection-target frame image data to be excluded in the synthetic data generation. In this situation, assuming that the specified frame rate is 60 fps and that twenty two frames of still images have been captured at a continuous shooting speed of 600 fps (with a shutter speed faster than 1/600 sec) the synthetic image generation unit 104d creates synthetic image data for a frame 3a corresponding to the continuous shooting speed of 60 fps (equivalent to a frame captured with a shutter speed of 1/60 sec) by combining the image data expressing the still images in the ten frames, i.e., the first through eleventh frames minus the image data in the rejection-target fifth frame.

In addition, the synthetic image generation unit 104d creates synthetic image data for a frame 3b corresponding to the continuous shooting speed of 60 fps (equivalent to a frame captured with a shutter speed of 1/60 sec) by combining the image data expressing the still images in the ten frames, i.e., the eleventh through twenty second frames minus the image data in the rejection-target thirteenth frame. The movie image generation unit 104e then creates movie image data with a frame rate of 60 fps with the synthetic image data for the frame 3a and the synthetic image data for the frame 3b each constituting a specific frame in the movie image data. Through these measures, movie image data can be created by automatically excluding any unwanted image, e.g., an image including an unwanted object or a blurred image (unfocused image) that may present among the images obtained through continuous shooting.

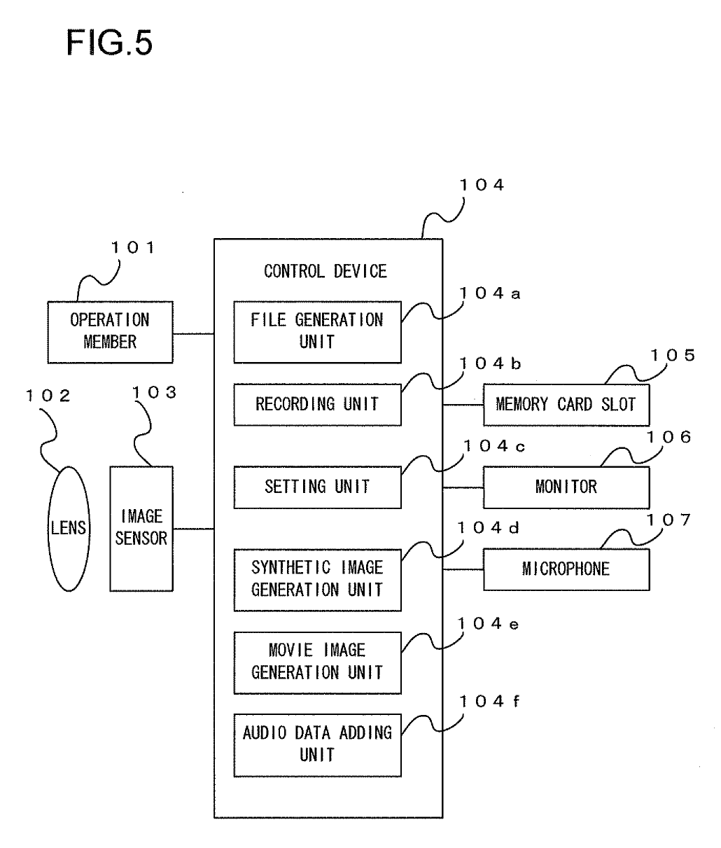

It is to be noted that provided that the camera 100 is equipped with a microphone for picking up ambient sound, the control device 104 may record audio data by picking up ambient sound through the microphone during a high-speed continuous shooting operation and reproduce the audio data when reproducing the movie image data having been generated. Such a camera equipped with a microphone 107 may be configured as shown in FIG. 5. The control device 104 in the figure has a further function fulfilled by an audio data adding unit 104f that records audio data by picking up ambient sound through the microphone during a high-speed continuous shooting operation and adds the audio data when reproducing the movie image data having been generated. The audio data adding unit 104f appends a time stamp to the audio data input thereto through the microphone 107 so as to maintain correct correspondence between frames of image data expressing specific still images and the audio data. Then, when the movie image data are reproduced, the audio data adding unit 104f reproduces the audio data by sustaining the correct correspondence between the individual frames constituting the movie image data expressing the movie image and the audio data based upon the time stamp so as to ensure that the movie image and the audio do not become asynchronous with each other.

The following advantages are achieved through the embodiments described above.

(1) The recording unit 104b records a plurality of image files obtained through a high-speed continuous shooting operation, into the memory card. Based upon the movie image frame rate specified by the user, the setting unit 104c sets a movie image frame rate. The synthetic image generation unit 104d generates a plurality of sets of synthetic image data by combining image data expressing a plurality of still images obtained through the high-speed continuous shooting operation. The movie image generation unit 104e creates a movie image file containing a movie image, each frame of which is constituted with a set of synthetic image data among the sets of synthetic image data having been generated, and the recording unit 104b records the movie image file thus created into the memory card. As a result, the plurality of image files generated through the continuous shooting operation and the movie image file generated based upon these image files can both be saved in the memory card where they are recorded.

(2) The synthetic image generation unit 104d generates synthetic image data by excluding the image data in any rejection-target frame that should be excluded in the synthetic image generation among the image data in the plurality of image files generated through a high-speed shooting continuous operation. As a result, an unwanted image is never included in the synthetic image data.

(3) The synthetic image generation unit 104d identifies image data of a frame with, for instance, an unwanted object present therein, a frame manifesting image blur due to hand movement or a frame in which a primary subject having been consistently present in preceding frames is missing, as a rejection-target frame to be excluded in the synthetic image generation. Through these measures, any image that is not desirable as a synthetic image generation source can be excluded.

(4) The audio data adding unit 104f records the ambient sound during a high-speed continuous shooting operation and reproduces the audio data along with the movie image file being reproduced. As a result, a movie image with sound can be played back.

(5) The audio data adding unit 104f appends a time stamp to the audio data and adds the audio data to the movie image being reproduced by maintaining the correct correspondence between the individual frames constituting the movie image data and the audio data based upon the time stamp. As a result, the audio being reproduced never becomes out of sync with the movie image during playback.

-Variations-

It is to be noted that the cameras achieved in the embodiments described above allow for the following variations.

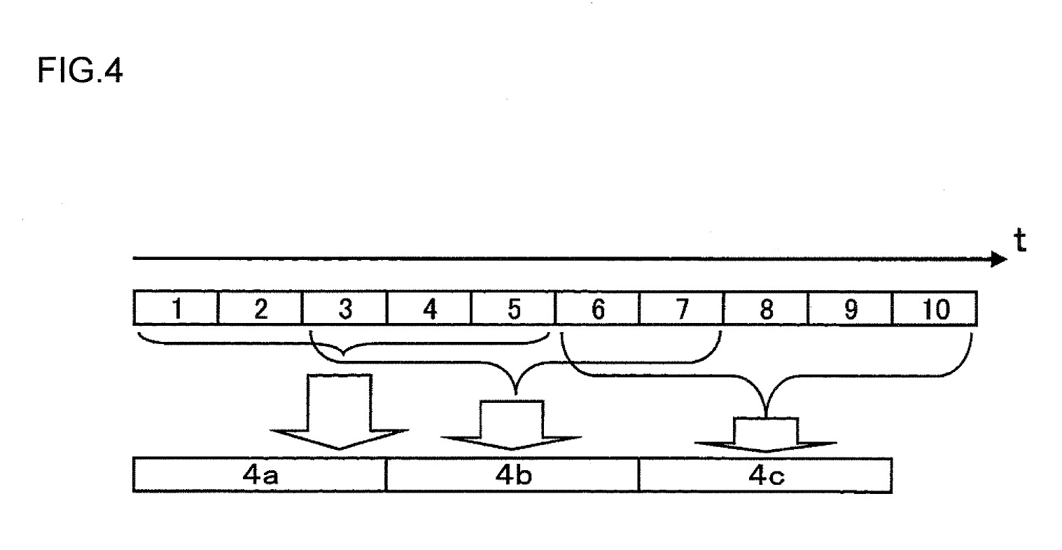

(1) The synthetic image generation unit 104d in the embodiments described above generates movie image data for each frame by combining image data expressing still images obtained in time series, the quantity of which corresponds to the movie image frame rate, as shown in FIG. 2 or FIG. 3. However, still images may be combined in a manner different from that shown in FIG. 2 or FIG. 3. For instance, the synthetic image generation unit 104d may use image data expressing some still images for purposes of generating synthetic image data corresponding to a plurality of frames, as shown in FIG. 4. Namely, in the example presented in FIG. 4, the synthetic image generation unit 104d generates synthetic image data for a first frame 4a of a movie image by combining the image data expressing the still images in the first five frames, i.e., first through fifth frames, among still images in ten frames having been shot through a high-speed continuous shooting operation. In addition, the synthetic image generation unit 104d generates synthetic image data for a second frame 4b in the movie image by combining the image data expressing the still images in five frames, i.e., third through seventh frames. The synthetic image generation unit 104d also generates synthetic image data for a third frame 4c in the movie image by combining the image data expressing the still images in five frames, i.e., sixth through tenth frames.

In this example, the image data corresponding to the third through fifth frames are used repeatedly for the generation of the synthetic image data in the first frame 4a of the movie image and the synthetic image data in the second frame 4b of the movie image. In addition, the image data corresponding to the fifth through seventh frames are used repeatedly for the generation of the synthetic image data in the second frame 4b of the movie image and the synthetic image data in the third frame 4c of the movie image. By repeatedly using the image data in the same frames for the generation of a plurality of frames to constitute a movie image as described above, a seamless and smooth movie image can be created.

(2) In the embodiments described above, the user specifies a frame rate for the movie image to be generated and the setting unit 104c sets a movie image frame rate based upon the movie image frame rate specified by the user. The synthetic image generation unit 104d generates a plurality of sets of synthetic image data by combining image data expressing a plurality of still images obtained through a high-speed continuous shooting operation. The movie image generation unit 104e then generates movie image data with each of the frames constituting the movie image made up with one of the plurality of sets of synthetic image data having been generated. As an alternative, the setting unit 104c may set a frame rate for the movie image to be generated that matches the display frame rate assumed at the display device 106 and movie image data may be generated via the synthetic image generation unit 104d and the movie image generation unit 104e at the frame rate thus set. As a further alternative, a preselected fixed value may be set as the frame rate for the movie image to be generated.

(3) In the embodiments described above, the recording unit 104b records a plurality of image files, obtained through a high-speed continuous shooting operation, into a memory card and movie image data are generated via the synthetic image generation unit 104b and the movie image generation unit 104e by using the image data in the image files recorded in the memory card. As an alternative, the recording unit 104b may detect available memory space in the memory card and record the plurality of image files obtained through continuous shooting into buffer memory instead of the memory card if the available space in the memory card is insufficient. In such a case, the synthetic image generation unit 104d and the movie image generation unit 104e may generate movie image data based upon the image data in image files recorded in the buffer memory.

(4) The control device 104 in the embodiment described above executes a high-speed continuous shooting operation at a shutter speed specified by the user, e.g., 1/600 sec. As an alternative, the control device 104 may automatically adjust the shutter speed for the high-speed continuous shooting operation in correspondence to the photographing environment. For instance, prior to the high-speed continuous shooting operation start, the control device 104 may detect movement of a photographic subject by calculating a subject movement vector among the individual frames constituting the live view image and may set a higher shutter speed if the detected subject movement is fast, and set a lower shutter speed if the detected subject movement is slow. As a further alternative, the control device 104 may detect a subject movement by calculating a subject movement vector from one frame to another during a high-speed continuous shooting operation and adjust the shutter speed accordingly.

Furthermore, movie image data may be generated by using, as a movie image generation source, still image data other than those expressing a plurality of images obtained through high-speed continuous shooting. For instance, movie image data may be generated by using a plurality of sets of image data obtained through regular continuous shooting executed at a shutter speed of 1/10 sec or by using a plurality of sets of image data each obtained through a separate shooting operation.

(5) In the embodiment explained in reference to FIG. 3, the synthetic image generation unit 104d identifies the image data in a rejection-target frame to be excluded in the synthetic image generation and generates synthetic image data for a given frame in the movie image by using image data in frames other than the rejection-target frame. As an alternative, the synthetic image generation unit 104d may replace the image data in the rejection-target frame with image data in an interpolated frame created through interpolation processing of the known art executed by using the image data in the frames preceding and succeeding the rejection-target frame in the timeline and the movie image generation unit 104e may generate a frame of the movie image by using the interpolated frame having been generated (by using the interpolated frame as a synthetic image generation source).

(6) In the embodiments described above, the quantity of image data combined to constitute each of the frames of the movie image being generated, which is determined in correspondence to the frame rate of the movie image being generated, remains unchanged. However, the numbers of frames of image data to be combined to generate individual frames of the movie image may be varied. For instance, in the embodiment described in reference to FIG. 2, the movie image frame 2a may be generated by combining a total of nine frames of image data among the first through tenth frames by excluding the fifth frame and then the movie image frame 2b may be generated by combining a total of ten frames, i.e., the eleventh through twentieth frames. In other words, some variance may be tolerated with regard to the number of frames of image data to be combined in order to generate each movie image frame, as long as the number of frames of movie image combined for purposes of synthetic image generation is in line with the frame rate of the movie image being generated and as long as it does not affect the movie image frame rate. For instance, some variance in the number of frames of image data used for purposes of synthetic image generation may be tolerated in conjunction with a photographic scene having a relatively high subject brightness and a slight change in the brightness, or in conjunction with a photographic scene in which the movement of the photographic subject does not change significantly.

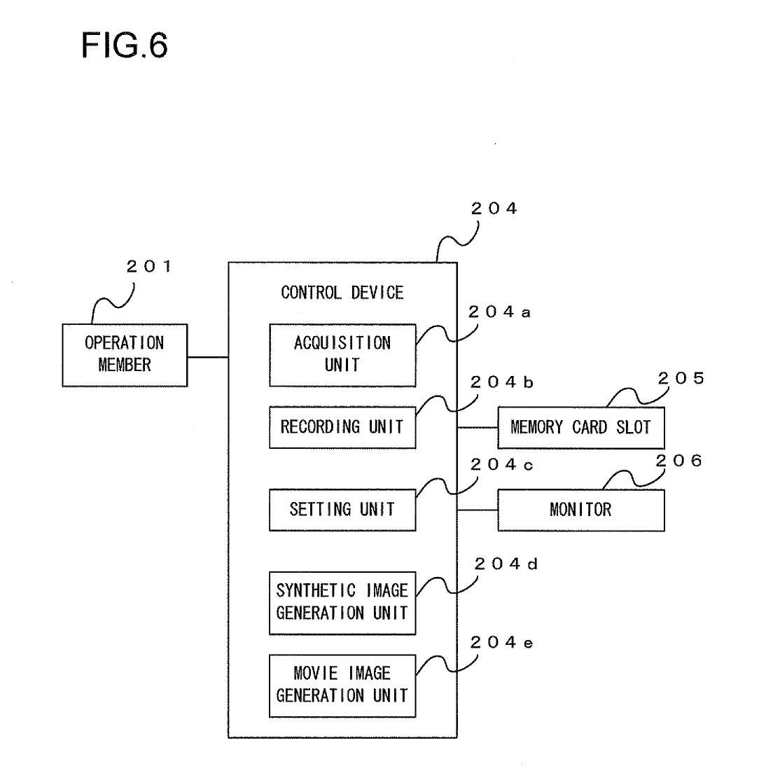

(7) While the embodiments described above are each achieved by adopting the present invention in a camera, the present invention is not limited to applications in cameras alone. For instance, it may be adopted in an image processing apparatus such as a personal computer equipped with an image processing function (image synthesis function). FIG. 6 shows a structure that may be adopted in such an image processing apparatus 200. The image processing apparatus 200 includes an operation unit 201, a control device 204, a memory card slot 205 and a monitor 206, The control device 204 has functions fulfilled via an acquisition unit 204a, a recording unit 204b, a setting unit 204c, a synthetic image generation unit 204d and a movie image generation unit 204e. The acquisition unit 204a takes in image data through a method known in the related art (e.g., receiving image data from a camera via wireless communication or wired communication, or directly receiving image data via a recording medium, which is initially loaded in a camera and can then be loaded at the image processing apparatus 200). The recording unit 204b saves the image data having been taken in by the acquisition unit 204a into a storage unit 200. The setting unit 204c, the synthetic image generation unit 204d, the movie image generation unit 204e and the monitor 206 respectively fulfill functions similar to those of the setting unit 104c, the synthetic image generation unit 104d, the movie image generation unit 104e and the monitor 106 of the camera 100 shown in FIG. 1. In other words, the image processing apparatus 200 has a function of taking in image data expressing images shot with a camera and a function of generating a movie image file assuming a given frame rate by using the image data having been taken in. Thus, once images having been shot with the camera are taken into the image processing apparatus such as a personal computer, the user is able to create a movie image with a desired frame rate at his convenience on a later date.

The above described embodiments are examples and various modifications can be made without departing from the scope of the invention.

What is claimed is:

1. A camera, comprising:
a photographing unit that generates image files by consecutively capturing subject images at an electronic shutter speed high enough to ensure that no image blur occurs in the subject images;
an image file recording unit that records image files into a storage medium, the image files being generated by the photographing unit;
a setting unit that sets a movie image frame rate;
a synthetic image generation unit that generates a plurality of synthetic images each by combining sets of image data in image files among a plurality of image files generated by the photographing unit, a quantity of the sets of image data being set by taking into consideration the frame rate set by the setting unit; and
a movie image file generation unit that generates a movie image file containing a movie image, each frame of the movie image being constituted with one of the synthetic images generated by the synthetic image generation unit.

2. A camera according to claim 1, further comprising:
a movie image file recording unit that records the movie image file generated by the movie image file generation unit into the storage medium.

3. A camera according to claim 2, wherein:
the synthetic image generation unit generates the synthetic images by excluding any image file that should not be used as a generation source when generating the synthetic images, among the plurality of image files containing the image data generated by the photographing unit.

4. A camera according to claim 3, wherein:
the synthetic image generation unit identifies an image with an unwanted object present therein, an image manifesting image blur or an image in which a primary subject having been consistently present in preceding images is missing, as the image file that should not be used as a generation source.

5. A camera according to claim 1, wherein:
the plurality of image files are generated through continuous shooting by the photographing unit.

6. A camera according to claim 5, further comprising:
a sound recording unit that records ambient sound while the continuous shooting executed by the photographing unit is in progress; and
an audio data adding unit that adds audio data obtained by the sound recording unit to the movie image file when the movie image is reproduced.

7. A camera according to claim 6, wherein:
the sound recording unit appends a time stamp to the audio data having been obtained; and
the audio data adding unit adds the audio data to the movie image file by maintaining correct correspondence between individual frames of the movie image and the audio data based upon the time stamp.

8. An image processing apparatus, comprising:
an acquisition unit that obtains a plurality of sets of image data generated in a camera that consecutively captures subject images at an electronic shutter speed high enough to ensure that no image blur occurs in the subject images;
a save unit that saves the plurality of sets of image data obtained via the acquisition unit;
a setting unit that sets a movie image frame rate;
a synthetic image generation unit that generates a plurality of synthetic images each by combining sets of image data in image files among a plurality of image files generated in the camera a quantity of the sets of image data being set by taking into consideration the frame rate set by the setting unit; and
a movie image file generation unit that generates a movie image file containing a movie image, each frame of the movie image being constituted with one of the synthetic images generated by the synthetic image generation unit.
